(19) United States
(12) Patent Application Publication
(10) Pub. No.: US 2025/0086580 A1
(43) Pub. Date: Mar. 13, 2025

(54) METHODS AND SYSTEMS FOR WORKFLOW MANAGEMENT VIA CONTROL DATA STRUCTURES

(71) Applicant: Segmatics, Inc., Oakville (CA)

(72) Inventor: Luis Lucca, Oakville (CA)

(21) Appl. No.: 18/465,760

(22) Filed: Sep. 12, 2023

(51) Int. Cl. G06Q 10/087; G06Q 10/0631; G06Q 10/0633; G06Q 10/0637; G06Q 10/067

(52) U.S. Cl. CPC G06Q 10/087; G06Q 10/06315; G06Q 10/0633; G06Q 10/06375; G06Q 10/067

(57) ABSTRACT

A product-specific supply chain is modeled and represented in a product control data structure. Each product control data structure includes a plurality of segmentation element identifiers for segmentation elements, and each segmentation element identifier includes a value or characteristic. The product control data structure is published and/or integrated into workflows of systems associated with entities that participate in the product-specific supply chain. The workflows evaluate custom rules based on a given product's segmentation elements and corresponding values or characteristics defined in the control data structure for purposes of making decisions, receiving recommendations for certain decisions, and/or performing actions defined by the custom rules to optimize a given entity's supply chain for a given product. In an embodiment and based on evaluation of the custom rules in view of the control data structure, the decisions, recommendations, and/or the actions are provided.

### BACKGROUND

Retailers, consumer packaged goods (CPG) companies, and distributors often offer a broad assortment of products to meet customers' needs. The demand pattern, importance, and attributes of these products can significantly be different from one another, and so are the service level requirements and supply chain cost implications. Historically, these organizations have partially or fully ignored these differences when managing their supply chain and planning the product-flow, from origin to destination to meet customer demand, resulting in sub-optimal performance.

Sub-optimal supply chain performance was exposed during the COVID-19 pandemic. Severe supply shortages were experienced worldwide during and following the pandemic. Supply chain issues still persist years post pandemic and supply chains have yet to fully recover. Pandemic supply issues magnified the need for technology, which can analyze products for purposes of optimizing supply chains and their workflows.

### SUMMARY

In various embodiments, methods and a system for workflow management via control data structures are presented. According to an embodiment, a method for generating a control data structure that controls a supply chain workflow is presented. Segmentation elements are used to group products of an entity into segments, based on data relevant to the products maintained by the entity and segmentation criteria predefined by the entity. For every product, a value or characteristic is assigned to each segmentation element, based at least on the data and segmentation criteria. A control data structure is generated; the control data structure represents the segment assignation for each product, including the segmentation elements and the corresponding value or characteristics of each segmentation element. The control data structure is provided to a workflow of an entity's system causing the system to perform one or more actions within the workflow based on the control data structure.

### BRIEF DESCRIPTION OF THE DRAWINGS

FIG. 1A is a diagram of a system for workflow management via control data structures, according to an example embodiment.

FIG. 1B is a diagram of an example control data structure, according to an example embodiment.

FIG. 2 is a diagram of a method for workflow management via control data structures, according to an example embodiment.

FIG. 3 is a diagram of another method for workflow management via control data structures, according to an example embodiment.

### DETAILED DESCRIPTION

Companies use their own knowledge bases and systems to optimally configure the product-flow (including in-store shelf capacities, packaging to supply the inventory, the distribution channel(s) for delivering the inventory to a destination, intermediate staging locations for the inventory before delivery to the destination, etc.) and optimally manage their supply chain. Each stage of decision-making can impact other stages of the supply chain, a company's overall profitability and can have adverse customer loyalty implications. Yet, existing knowledge bases and systems fail to adequately consider and understand all the supply-chain dependencies that are inherent to a given product and inherent to a given company's sales of the product. Moreover, companies can offer a broad assortment of products to their customers, with hundreds, thousands, or hundreds of thousands of products, each requiring a set of supply chain decisions, which makes it almost impossible to customize to each specific product characteristics and needs to optimize the product-flow and overall supply chain performance.

As a result, companies plan the product-flow and manage their supply chains at coarse grained levels of detail and currently lack the technology which would permit them to manage their supply chains at a fine-grained level of detail. These shortcomings became apparent during the pandemic; in fact, supply chains have still not fully recovered.

These issues are solved with the teachings provided herein. A product-specific supply chain is modeled as a product control data structure. The control data structure drives supply chain decisions made by an entity. Each product control data structure represents a given product's supply chain ‘segment’ for a given entity, and each segment includes a plurality of segmentation elements. Furthermore, each segmentation element has a value or characteristic, specific to every product. By grouping large numbers of products into a limited number of segments, based on key product characteristics, companies can create and manage custom product-flow and supply chain rules at the segment level, simplifying the task without loosing sight of key product characteristics.

The product-specific control data structure is published and/or provided to workflows of systems associated with entities that participate in supply chain decision making. The workflows evaluate custom supply chain rules based on a given product's segmentation elements and value or characteristic defined in the control data structure for purposes of making automated decisions, making automated recommendations, and/or performing automated actions to plan the product-flow from origin to destination and to optimize an entity's supply chain for the given product. In an embodiment, recommendations for the decisions and/or the actions are provided/linked with/to the product control data structure and/or the recommendations are embedded in the supply chain rules.

As used herein, “supply chain” refers to a network of people, assets, processes, and technology involved in the creation, distribution, and sale of products. The phrase “supply chain management” refers to the initiatives/activities performed within the supply chain to align decision-making from different functional groups, teams, or individuals at different points-in-time, for purposes of maximizing and/or optimizing sales and reducing system-wide cost.

The term “product” can be used interchangeably and synonymously with the term “item,” “good,” and/or “merchandise.” A “workflow” refers to a sequence of operations performed by a system to perform an automated action, make a supply chain recommendation, and/or make a supply chain decision.

The term “packager” is used to identify a company that packages a product. A packager can also be the manufacturer of the product. A “supplier” is used to identify a company that supplies the product of a packager to a distributor; in some instances, the supplier may also be the manufacturer of the product. A CPG is an entity that packages the product and then provides the product directly to a retailer for resale to a consumer. A “distributor” is a company that provides the product of a packager directly to a retailer. As used herein the terms “company,” “entity,” “establishment,” and/or “business” may be used interchangeably and synonymously; this refers to either a manufacturer, a retailer, a distributor, or a CPG company. An entity is any organization that manages/handles a product along a supply chain from a source to a destination.

“Product-flow” refers to the flow path and the pace/rate which products are moved throughout the supply chain. The “path,” also known as distribution channel, refers to the physical locations/facilities (e.g., manufacturing plants, ports, national distribution centres, regional distribution centers, 3PLs (third-party logistic providers), and/or stores) that the products are stocked at and/or moved through, to reach their destination. It refers also to physical areas within the distribution centres products move through, which correspond to specific processes and technologies to manage/handle different packaging and/or modes of distribution (e.g., stock, cross-dock, pick-to-zero, case-picking, unit-picking). The ‘pace’ refers to the rate of movement. Supply chains should provide fast and frequent deliveries from one node to another, or on the contrary, periodic replenishment with longer lead times.

Different product-flow configurations provide diverse levels of service (i.e., response and reaction to customer orders) as well as different supply chain cost implications. For example, a distributor might choose to keep inventory for one product in all its five distribution centres across the country, to react quickly to customer orders. Alternatively, it can choose to keep stock in only one central facility nationwide, to better control inventory levels, albeit longer lead time to customers. By understanding how different product-flow configurations (decisions or actions) best suit different segmentation elements to maximize sales and reduce system-wide cost, organizations can embark in the process to maximize the alignment.

Supply chain “segmentation” refers to dividing the entire universe of products (i.e., available products) sold by an entity into groups, subsets, or segments, based on similar characteristics, such as the ones found in the products' demand pattern, importance, and attributes.

“Segmentation elements” represent the different approaches, variables, or axis in which a universe of products can be separated or split into groups of homogeneous products. For example, products can be grouped based on several segmentation elements, such as velocity, where each product of an entity is assigned a value/characteristic of high-moving, medium-moving, or slow-moving, based on each individual product rate of sales. This would create three distinct groups within the universe of products of an entity. Similarly, products can be grouped based on seasonality (e.g., highly seasonal, all year), and volatility (i.e., predictable versus unpredictable demand), category-strategy (e.g., traffic builders, profit generators, excitement creating, etc.), vendor reliability, and COVID-Critical (e.g., Yes or No). Products can also be grouped based on physical characteristics, such as dimensions (e.g., large/bulky, or small), cost (e.g., expensive versus inexpensive), weight, hazardous, conveyable, etc.

“Segmentation criteria” refers to the rule or set of rules, within each segmentation element, which split the universe of products or available products of an entity into groups of homogeneous products. For example, within the segmentation element ‘physical dimensions’, a rule would classify any product having a physical dimension (i.e., height×width×length) larger than 10 cubic feet, as having a characteristic or value of ‘large/bulky’.

In an embodiment, the “product control data structure” is a collection of fields, which include, for every product, a plurality of segmentation elements together with their corresponding value or characteristic. It can also include a string, which summarizes all the segmentation elements and corresponding values or characteristics.

“Service level” refers to ability of the supply chain to meet the customers needs and expectations. Customers usually have a different expectation for different products. Customers expect certain items/products, which are vital and regularly consumed by the customers, to be available for immediate purchase when the customer needs the products, for example, toilet paper, milk, eggs, batteries, etc. Conversely, other products are not regularly needed or used by customers, such as a picture frame, a hammer, etc.

“Supply chain rules” refer to one or several principles governing certain decision-making in the supply chain. To create, distribute and sale products, entities need to make a series of decisions, which impact the service level offered to customers and supply chain cost implications for each product. These might involve product-flow setup, in-store shelf capacities, packaging to supply the inventory, the distribution channel(s) for delivering the inventory to a destination, intermediate staging locations for the inventory before delivery to the destination, etc. These entities often offer a broad assortment of products to meet customers' needs. The demand pattern, importance, and attributes of these products can significantly differ from one another, and so can the service level requirements and supply chain cost implications. Therefore, supply chain rules might dictate a different action based on different product characteristics. For example, a retailer might offer their customers garden supplies (e.g., bags of soil), electronics (e.g., smartphones), furniture (e.g., dining tables) and dairy products (e.g., 2L (liter) milk jugs). These four product examples can significantly differ in the number of units sold per year, seasonality, physical dimensions and weight, cost, margin, temperature requirements, country of origin, etc. Even within the same department/category of products such differences can exist. Consequently, optimal process-flow for smartphones might be different to the one for milk, bags of soils, etc.

A “workflow” refers to a processing sequence of operations executed on a device. A “system” refers to one or more software applications and/or software services that execute on one or more servers. A system, by way of example only, can include an inventory system, a scheduling system, a transaction system, or any supply chain or product-related data management set of software applications and/or services.

An “action” refers to one or more operations processed based on the processing sequence of a given workflow. By way of example only, an “action” can include a single operation that is processed within a workflow to update a single field of a data store/database/table, a set of operations that is processed within a workflow to update multiple fields of one or more data stores/databases/tables, one or more application programming interface (API) operations processed within a workflow to activate or send a message to a different workflow of a different system associated with a given entity or a plurality of entities, one or more operations processed within a workflow that activates or notifies a given application or service within a same system associated with a same entity, etc.

A “decision” refers to processing one of a plurality of available actions based on supply chain rules or conditions defined within a workflow. A “recommendation” refers to a suggestion or a proposal to perform a given decision based on supply chain rules or conditions defined within a workflow.

In an embodiment, an action is an operation processed to provide a decision or a recommendation for a decision. In an embodiment, an action is an operation to send a notification of a decision or a recommendation to a resource (e.g., personnel, systems, applications, software services, etc.). In an embodiment, an action is an operation processed to publish the decision or recommendation on an accessible network storage location. In an embodiment, an action is an operation processed to update a data store/table with the decision or recommendation.

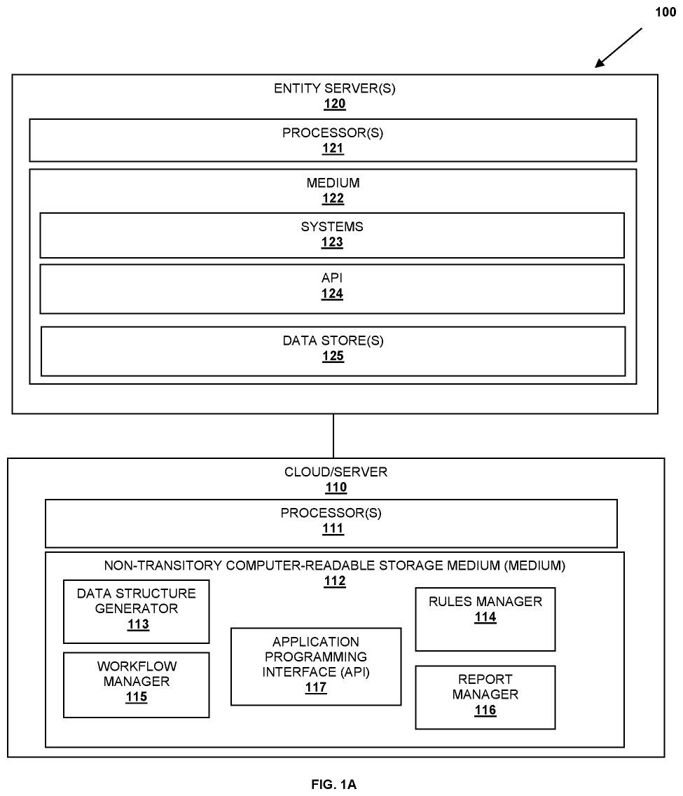

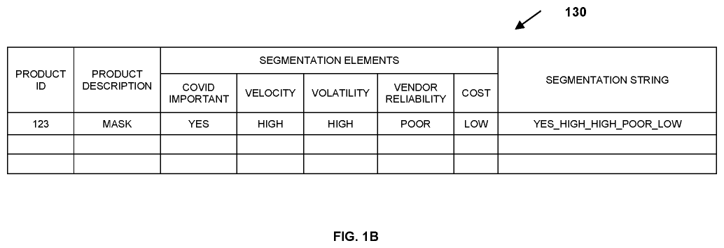

Within this initial context system/platform 100 (hereinafter “system 100”) is discussed with reference to FIG. 1A. FIG. 1A is a diagram of a system 100 for workflow management via control data structures, according to an example embodiment. The various components are illustrated, and the arrangement of the components is presented for purposes of illustration only. It is to be noted that other arrangements with more or less components are possible without departing from the workflow management via control data structures teachings presented herein and below.

The techniques, methods, and system presented herein and below for workflow management via control data structures can be implemented in whole or in part, in one, in all, or in combination of the components shown with the system 100. The techniques and methods are programmed as executable instructions in memory and/or non-transitory computer-readable storage media and processed on one or more processors associated with the various components.

System 100 includes a cloud/server 110 (hereinafter just “cloud 110”) and a plurality of entity servers 120. Cloud 110 includes at least one processor 111 and a non-transitory computer-readable storage medium (herein after just “medium”) 112, which includes instructions for a data structure generator 113, a rules' manager 114, a workflow manager 115, a report manager 116, and application programming interface (API) 117. The instructions when executed by processor 111 cause processor 111 to perform operations discussed herein with respect to 113-117.

Each entity server 120 includes at least one processor 121 and medium 122, which includes instructions for systems 123 application programming interface (API) 124. The instructions when executed by processor 121 cause processor 121 to perform operations discussed herein with respect to 123-124. Medium 122 also includes at least one data store 125.

Data store 125 includes a variety of entity-maintained data, which at least includes cross-functional supply chain management data. For example, data store 125 includes product master data (e.g., product catalogue), vendor master data, store/customer data, facility data, warehouse alignment data, delivery schedule data, store replenishment settings data, vendor-to-warehouse replenishment setting data, transactional data, etc.

Product master data (may also be referred to herein as “product catalogue” or “Item Master”) includes the entity's product identifiers, product descriptions, product statuses (e.g., active, discontinued, etc.), universal product codes (UPCs), cube dimensions for the products, weights for the products, warehouse packaging configuration data for the products, manufacturer packaging configuration data for the products, pallet tie-high configuration data for the products, temperature requirements for the products, any hazardous flags for the products, vendor identification numbers/identifiers associated with the products, etc. Vendor data includes vendor identification numbers, vendor remittance addresses, vendor shipping addresses, etc.

Store/Customer data includes store/customer identification numbers, descriptions, store/customer type, store/customer banner, store/customer address, etc. Facility data includes facility identification number, description, address, etc. Warehouse alignment data includes product identification number, identification number of the facility responsible for fulfilling the corresponding store/customer with the corresponding product, minimum order quantities (MOQ) required, etc. Delivery schedule data includes store identification number, warehouse identification number, days of week with deliveries, etc. Store replenishment settings data includes product identification number, store identification number, days of week with deliveries, forecast settings, maximum shelf capacity, minimum shelf capacity, minimum presentation, etc. Vendor-to-warehouse replenishments data settings include warehouse identification number, the warehouse identification number that the entity services, order days, lead time, planogram data, etc.

Transactional data includes point-of-sale (POS) data, store inventory data, forecast data, purchase order data, outbound ship data, etc. POS data include product identification number, store/customer identification numbers, transaction terminal identifiers by store, date of sales, units sold, unit-of-measure, currency, etc. Store inventory data includes product identification number, store identification number, units on-hand, unit of measure, etc. Store inventory data is maintained for brick-and-mortar stores and/or dark stores for e-commerce. Forecast data includes product identification, store/customer identification number, units forecasted, unit-of-measure, etc. Purchase order data includes product identification number, vendor identification number, destination identification number, purchase order type, order date, expected arrival date, actual arrival date, original order quantity, modified order quantity, received quantity, unit-of-measure, etc. Outbound shipping data includes product identification number, warehouse identification number, date, units ordered by customers, units shipped to customers, unit-of-measure, etc.

As used herein, “supply chain data” refers to all or any combination of the above-noted data types. “Product-specific supply chain data” refers to the above-noted data types for a given product. The data types include product data, vendor data, store/customer data, facility data, warehouse alignment data, delivery schedule data, store replenishment settings data, vendor-to-warehouse replenishment settings data, POS data, store inventory data, forecast data, purchase order data, outbound shipping data, inbound shipping data, etc. Supply chain data may also be referred to as “data relevant to a given product,” “data relevant to a given product and a given entity,” or “data relevant to a given supply chain of a given product.”

Notably, although a single data store 125 is illustrated, there can be a plurality of data stores 125 managed for or controlled by a given entity. For example, a given entity includes a transactional data store 125, an inventory data store 125, a product data store 125, etc.

Initially, data structure generator 113 obtains historical data and/or any of the above-referenced product supply chain data for an entity, from a given entity's data store(s) 125 using API 124. The data structure generator 113 cleans and processes the historical and supply chain data by product, preparing it to be segmented. This preparation can include the utilization of mathematical formulas, including but not limited to averages, standard deviations, unit of measure conversions, multiplications, maximums and/or minimums, etc.

In an embodiment, the data structure generator 113 also obtains segmentation criteria for each of the segmentation elements considered in the segmentation process of an entity. In an embodiment, the segmentation criteria are stored in a table or data store by entity on cloud 110. In an embodiment and initially, the segmentation criteria are acquired from an interface rendered on an enterprise device by cloud 110. For example, the interface is rendered through web pages of a web browser or via a mobile application for any mobile device operated by the entity to interact with cloud 110 and provide specific criteria for each segmentation element. The segmentation criteria determine for each product, the value or characteristic for each segmentation element; for example, a criticality of product to the entity based on an entity-defined scale (e.g., 1 to 10 with 10 being the most critical, etc.).

Next, data structure generator 113 determines, for every product, a value or characteristics for all segmentation elements considered in the segmentation process for the entity. In an embodiment, a set of values or characteristics are determined for each segmentation element; the set includes at least one value or characteristic a set.

Using the segmentation element ‘Velocity’ as an example, the data structure generator 113 would receive historical sales (i.e., a portion of the product supply chain data) from data store(s) 125. The data structure generator 113 prepares/processes the historical sales data by computing the rate-of-sale or average units sold per week for every product. Using segmentation criteria obtained from cloud storage or an interface rendered on an enterprise device by cloud 110, the data structure generator 113 assigns a value or characteristic of “Velocity: High” to any product selling over 100 units per week on average as directed by the entity's segmentation criteria. Products selling between 50-100 units per week are assigned “Velocity: Medium” and any products selling under 50 units per week are assigned a “Velocity: Slow.” Continuing with the previous example, for the segmentation element ‘Conveyable’, data structure generator 113 assigns the value or characteristic “Conveyable: Yes” or “Conveyable: No” to each product by comparing each product's physical dimensions and weight with those in the corresponding segmentation criteria. Similarly, the cost segment historical data and/or product supply chain data indicate that the product has excessive cost such that the cost characteristic is assigned a “Cost: High” characteristic based on a predefined range within the criteria.

After the segmentation elements and corresponding values or characteristics are determined, the data structure generator 113 summarizes the segmentation results, creating a control data structure for every product of the entity. The control data structure represents the segment assignation to every product. The control data structure is a collection of fields, which include, for every product, a plurality of segmentation elements together with their corresponding value or characteristic represented in a table. The control data structure can be rendered in a variety of formats; for example, the control data structure can be rendered as a string, which summarizes all the segmentation elements and corresponding values or characteristics. See FIG. 4.

In an embodiment, the control data structure is a table managed by product per entity. The columns and rows of the table are combined to identify a given control data structure for a given product of a given entity. In an embodiment, a given record is field based to identify each of the segmentation elements and the corresponding values or characteristics in a cell (column and row intersection) of the table.

FIG. 1B is a diagram of an example control data structure 130, according to an example embodiment. Product identifier (ID) is the product code used by the entity to identify each individual product with the entity system. In FIG. 1B, row 123 identifies a record for the example product code. The segmentation elements are identified in the columns labeled COVID Important, Velocity, Volatility, Vendor Reliability, and Cost. Optionally, a Product Description field can be included in the record for product 123. The cells of the record identify the segmentation characteristics or values as ‘Yes’ for Covid Important, ‘High’ for Velocity, ‘High’ for Volatility, ‘Poor’ for Vendor Reliability, and ‘Low’ for Cost. The last column of the record of the control data structure 130 is presented or rendered in a string format identified by “YES_HIGH_HIGH_POOR_LOW.” For example, the position and location of each of the characteristics or values correspond to a specific segmentation element, such that the segmentation elements themselves do not have to be identified within the string-rendered format of the control data structure 130. Notably, as remarked above, the control data structure 130 can be rendered in a variety of formats other than the string format example presented in FIG. 1B.

In an embodiment, the control data structure is equivalent to or represents a deoxyribonucleic acid (DNA) code for a given product, where all the segmentation information is encoded and carried along the entity workflows to trigger optimal decisions, using segment-based supply chain rules. That is, a product's historical data and/or supply chain data as recorded, noted, and captured in an entity's historical data and/or product supply chain data is cleansed, processed, and analyzed against segmentation criteria, modeled within the control data structure to capture and define, within a single DNA code (control data structure), the make-up, the essence, behaviors, movements, and the value of the product to the entity. The entire supply chain for the product is managed via the product's DNA code by driving actions, decisions, and/or recommendations based on the segmentation elements, characteristics, and characteristic values defined within the product's DNA code. The product's DNA code condenses, summarizes, captures, and quantifies the entity's knowledge of a given product's supply chain.

In an embodiment, data structure generator 113 is reprocessed at a predefined or preconfigured interval of time based on updated product-specific supply chain data for products of the entity. This causes one or more of the product control data structures to be updated with revised segmentation elements and/or characteristic values by segment.

In an embodiment, data structure generator 113 is a trained machine learning model that receives the product supply chain data, the segmentation elements, and the corresponding segmentation criteria for the segmentation elements as input for a given entity and provides as output the product-specific control data structures by product.

Once a control data structure is generated for each of a given entity's universe of available products, Workflow manager 115 retains and manages the product-specific control data structures for each product of subscribing entities to cloud 110. The control data structure drives/causes workflow processing by systems 123 of the entity servers 120. This is achieved through the processes explained below.

Rules' manager 114 maintains supply chain rules for actions, decisions for actions, and/or recommendations for decisions, such as the ones needed to define the ‘product-flow’ from origin to destination, and other supply chain decisions for every product. These supply chain rules are set by the entity and are based on the control data structure as a whole, based on a given segmentation element and corresponding value or characteristic, and/or based on combinations of segmentation elements and their corresponding value or characteristics. Actions, decisions, and/or recommendations are associated with a given product and a given entity and/or a given product and a plurality of entities.

By way of example only, in a scenario where five segmentation elements were being considered in the segmentation process of a particular entity, a rule within rule manager 114 would indicate that products having a control data structure that include the following values or characteristics would need inventory in all available warehouses of the entity, as a mean to avoid shortages and improve customer service: (1) COVID-Important: Yes, (2) Velocity: High, (3) Volatility: High, (4) Vendor-Reliability: Poor, (5) Cost: Low, which is illustrated in the example control data structure 130 of FIG. 1B. Similarly, other decisions are aligned to the control data structure, such as packaging configuration; the inventory distribution channels and channel locations for staging the product inventory; in-store shelf/display quantities to maintain for the product within a given store, etc.

In an embodiment, rules manager 114 includes a trained machine learning model that receives as input product-specific control data structures and real-time supply chain data for an entity and provides as output an action, a decision, and/or recommendation based on the control data structure.

Workflow manager 115 links each segmentation element of a control data structure, combinations of segmentation elements of the control data structure, and/or the control data structure as a whole for a given product's control data structure to the corresponding supply chain rule(s) within rules' manager 114. Workflow manager 115 uses the supply chain rules and the control data structure to identify decisions for every product, which would ultimately optimize the product-flow and supply chain management of the given product. Workflow manager 115 also identifies the actions needed in the workflow of system 123 to communicate and systematically execute the decisions. Following the example above for FIG. 1B, where some products would need inventory in all available warehouses, workflow manager 115 would identify the actions, such as values and fields to be updated in the product catalog, to communicate and/or execute the decision.

Workflow manager 115 provides the outputted action, decision, recommendation for a given product via API 117 to enhanced workflows of systems 123 or workflow manager 115 publishes or makes accessible the outputted action, decision, and/or recommendation to systems 123.

In an embodiment, the existing workflows of systems 123 are enhanced to provide, via API calls, real-time product supply chain data posted or received within data store(s) 125. In response to the real-time product supply chain data provided with the API call, workflow manager 115 obtains the relevant supply chain rules for the corresponding product control data structure associated with the corresponding product, evaluates the linked rule(s) in view of the real-time product supply chain data, and returns the action(s), decision(s), and/or recommendation(s) to the enhanced workflow of system 123 based on processing the corresponding rule(s). This causes the enhanced workflow to automatically process a corresponding action, to automatically provide a corresponding decision, and/or to automatically provide a corresponding recommendation.

In an embodiment, workflow manager 115 publishes or provides a given entity's product-specific control data structures and linked supply chain rules to systems 123 of the entity. In an embodiment, systems 123 manage the product-specific control data structures and linked supply chain rules independently of cloud 110.

In an embodiment, workflow manager 115 monitors real-time data relevant to a product-specific supply chain for a given entity for compliance at preconfigured intervals of time. This is based on actual actions, decisions, or recommendations taken by the entity to ensure the actual actions, decisions, or recommendations match or do not match the actions, decisions, or recommendations provided by the workflow manager 115. The actual actions, decisions, or recommendations are identified in updated product supply chain data, captured in data store 125, obtained via API 124 causing workflow manager 115 to evaluate the updated data for compliance.

In an embodiment, workflow manager 115 provides and/or integrates a given product-specific control data structure and corresponding supply chain rules to/into at least two workflows associated with the entity and an additional entity. That is, multiple entities and their systems 123 handle a given product such as a retailer, a packager, a distributer, a supplier, etc. The control data structure and corresponding supply chain rules are provided to two or more of the entities that handle the given product. In this way, supply chain optimization can be realized by two or more of the entities involved in handling the product.

In an embodiment, the action includes processing one or more operations to update a given field or set of fields associated with the product in a product catalogue with the control data structure, or to update multiple fields associated with the product in the product catalogue with certain portions of the control data structure. In an embodiment, the action includes processing one or more operations to notify certain personnel of the entity of the product's control data structure. In an embodiment, the action includes processing one or more operations to publish the product's control data structure in a storage location accessible to certain personnel of the entity or accessible to one or more of the systems 123 associated with the entity or different systems 123 associated with different entities. In an embodiment, the action includes processing one or more operations to update a given field or set of fields associated with the supply chain decisions, so they can be communicated or systematically executed.

In an embodiment, system 100 includes report manager 116. Report manager 116 obtains historical data and/or supply chain data for an entity, from a given entity's data store(s) 125 using API 124. Report manager 116 also obtains the actual data for the decisions made and/or actions taken from data store(s) 125 using API 124.

The report manager 116 provides reports for compliance of the actual decisions and/or actions in view of corresponding supply chain rules associated with the segmentation elements of the product-specific control data structures. The granularity of the reports is configurable. For example, report manager 116 can provide reports with granularity by segment, by custom combinations of segmentation elements, by a segmentation element, by a given category of products, by product, etc. The reports are provided through interfaces to entity-operated devices; for example, via a browser interface, via a mobile application interface, etc.

Report manager 116 computes supply chain performance indicators (for service level and supply chain cost) and provides performance reports. The granularity of the reports is configurable as explained above, by segment, segmentation elements, products, or other available information and the entity, such vendor, hierarchy (e.g., department, category of products), teams, product manager. The reports are provided through interfaces to entity-operated devices; for example, via a browser interface, via a mobile application interface, etc.

System 100 permits automated actions, automated decisions, and/or automated recommendations with respect to a given product or a given category of products based on the corresponding control data structures and corresponding linked supply chain rules. Conventionally, supply chain decisions are made when requested, based on ad hoc or existing knowledgebases, often when the decisions are made, they are already too late and have already adversely impacted the supply chain of an entity. System 100 provides day-to-day proactive decisions and automated actions, decisions, and/or recommendations on a product-specific or product-category basis. The level of detail and granularity is a fine-grained approach rather than conventional coarse-grained approaches. A given product's supply chain data is modeled within its control data structure.

The control data structure is broken down into segmentation elements associated with the product's supply chain and each segmentation element includes values or characteristics. Supply chain rules are linked to the control data structure as a whole, to a given segmentation element of a control data structure, and/or to combinations of segmentation elements of a control data structure. The supply chain rules are evaluated against real-time product specific supply chain data on a daily basis or any configured interval of time using the segmentation elements and corresponding values or characteristics to produce or to generate an automated action, an automated decision, and an automated recommendation for a decision with respect to a given product. Thus, untimely conventional supply chain decisions that are based on ad hoc and coarse-grained data are eliminated with system 100 and replaced with proactive and anticipatory product-specific supply chain actions, decisions, and/or recommendations made daily based on product-specific control data structures, which model each product's supply change data as experienced and as expected/planned by a given entity or a set of entities. In an embodiment, the supply chain rules are predefined and customized for a given entity and a given product of the entity.

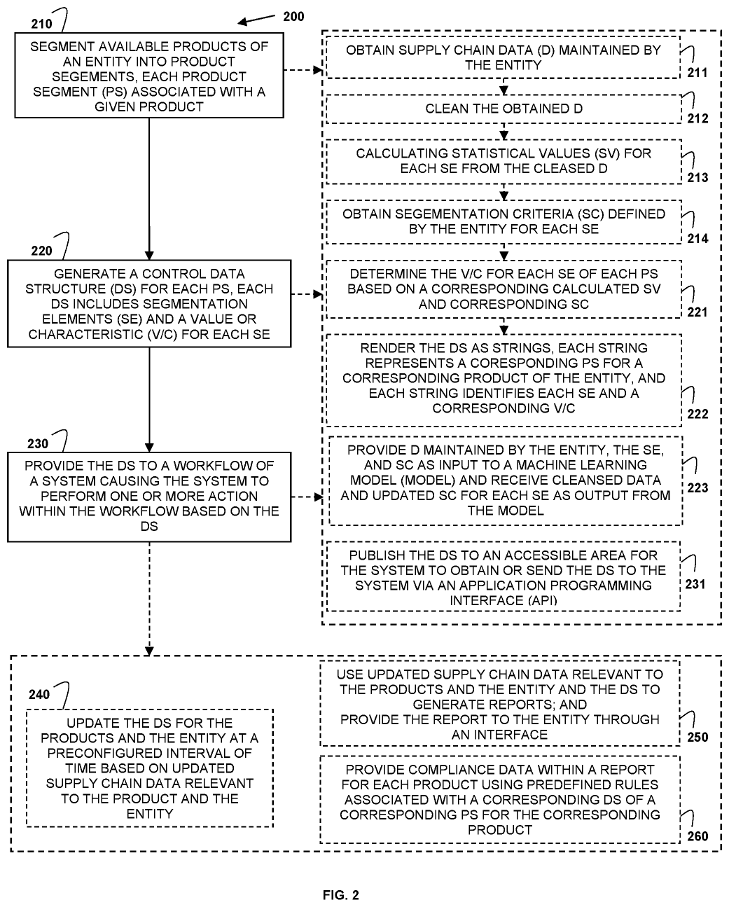

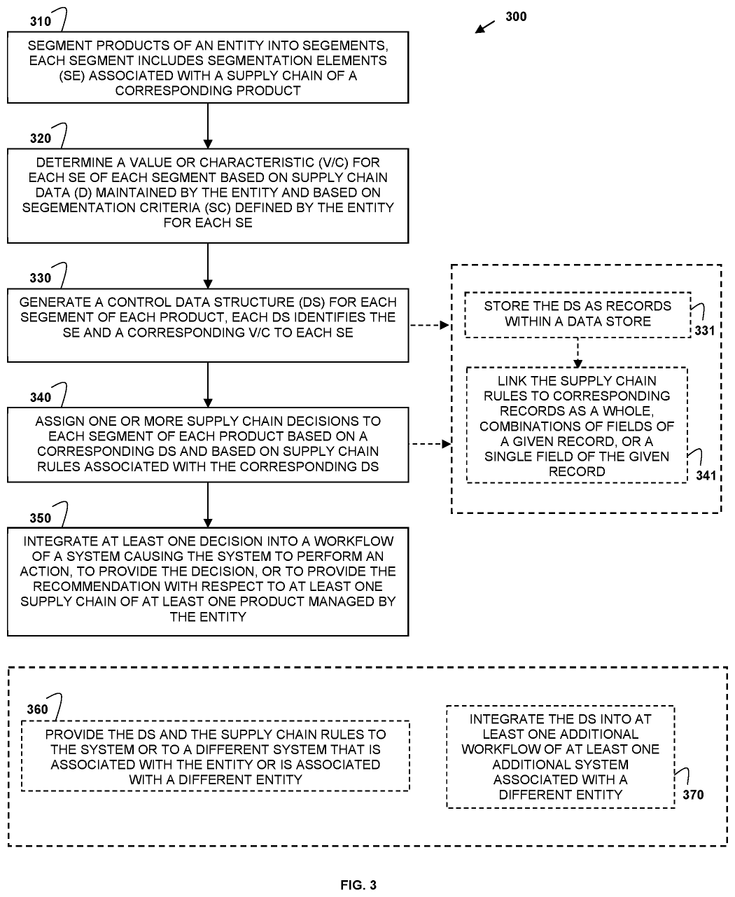

The above-referenced embodiments and other embodiments are now discussed with reference to FIGS. 2 and 3. FIG. 2 is a diagram of a method for workflow management via control data structures, according to an example embodiment. The software module(s) that implements the method 200 is referred to as a “product-specific supply chain controller.” The product-specific supply chain controller is implemented as executable instructions programmed and residing within memory and/or a non-transitory computer-readable (processor-readable) storage medium and executed by one or more processors of a device. The processor(s) of the device that executes the product-specific supply chain controller are specifically configured and programmed to process the product-specific supply chain controller. The product-specific supply chain controller provider has access to one or more networks during its processing. The networks can be wired, wireless, or a combination of wired and wireless.

In an embodiment, the product-specific supply chain controller is executed by cloud 110 or server 110. In an embodiment, the product-specific supply chain controller is data structure generator 113, rules manager 114, workflow manager 115, report manager 116, and/or API 117.

At 210, the product-specific supply chain controller segments available products of an entity into product segments or product supply chain segments. Each product segment is associated with a given product.

In an embodiment, at 211, the product-specific supply chain controller obtains supply chain data maintained by the entity. For example, API 117 and/or API 124 is/are processed to obtain the types of data discussed above from data store(s) 125 associated with a server 120 of the entity.

In an embodiment of 211 and at 212, the product-specific supply chain controller cleanses the obtained data. For example, sales data can include sales for a given product that are obviously incorrect because an extra digit to the number of sales was added or removed. The manner in which the data is cleansed can be defined in cleansing rules obtained from or defined by the entity. The product-specific supply chain controller evaluates the cleansing rules to provide cleansed data from the obtained data at 211. As used herein, “clean,” “cleansing,” “cleansed” and/or “cleaning” is intended to mean the original obtained data is corrected or modified to correct obvious errors defined by cleansing rules.

In an embodiment of 212 and at 213, the product-specific supply chain controller calculates a statistical value for each segmentation element from the cleansed data. For example, the product-specific supply chain controller calculates average sales of a given product, a standard deviation for units sold for a given product, etc.

In an embodiment of 213 and at 214, the product-specific supply chain controller obtains segmentation criteria defined by the entity for each segmentation element. The segmentation criteria define rules for using the calculated statistical values and assigning a value or characteristic to each segmentation element.

At 220, the product-specific supply chain controller generates a control data structure for each available product. Each control data structure includes segmentation elements and a value or a characteristic for each segmentation element.

In an embodiment of 214 and 220, at 221, the product-specific supply chain controller determines the value or characteristic for each segmentation element of each product segment based on the corresponding calculated statistical value and corresponding segmentation criteria. For example, the product-specific supply chain controller uses segmentation criteria which assigns a high value to any statistical value above a threshold for a given segmentation element of a given product.

In an embodiment of 221 and at 222, the product-specific supply chain controller renders the data structures as strings. Each string represents a corresponding product segment for a corresponding product of the entity. Each string identifies each segmentation element and a corresponding value or characteristic. In an embodiment, the segmentation element is inferred based on its field position within the string. In an embodiment, the string includes a segmentation element identifier for each segmentation element followed immediately by a corresponding value or characteristic for that segmentation element.

In an embodiment, at 223, the product-specific supply chain controller provides supply chain data maintained by the entity, the segmentation elements, and segmentation criteria for each of the segmentation elements as input to a machine learning model (model). Responsive to the input, the model returns as output cleaned supply chain data for the supply chain data and updated segmentation criteria for each of the segmentation elements as output. The product-specific supply chain controller uses the cleansed supply chain data and updated segmentation criteria to generate the control data structures for the product segments of the available products at 220.

At 230, the product-specific supply chain controller provides the data structures to a workflow of a system 123. This causes the system 123 to perform one or more actions within the workflow based on the data structure, its corresponding segmentation elements, and each value or characteristic assigned to each segmentation element.

In an embodiment, at 231, the product-specific supply chain controller publishes the data structures to an accessible storage area that is accessible to the system 100. In an embodiment, at 232, the product-specific supply chain controller sends the data structures to the system 123 via an API 117.

In an embodiment, at 240, the product-specific supply chain controller updates the data structures for the available products and the entity at a preconfigured interval of time, based on updated supply chain data relevant to the product and the entity. That is, the data values change over time within the supply chain data, based on actual decisions and sales of the entity. Accordingly, the product-specific supply chain controller processes the updated data to update the control data structures at preconfigured intervals of time.

In an embodiment, at 250, the product-specific supply chain controller uses updated supply chain data relevant to the products and the entity and uses the control data structure to generate reports. The product-specific supply chain controller provides the reports to the entity through an interface.

In an embodiment, at 260, the product-specific supply chain controller provides compliance data within a report for each product using predefined rules associated with a corresponding control data structure of a corresponding product segment for the corresponding product.

FIG. 3 is a diagram of another method for workflow management via control data structures, according to an example embodiment. The software module(s) that implement the method 300 is referred to herein as a “product-specific supply chain manager.” The product-specific supply chain manager is implemented as executable instructions and programmed within memory and/or a non-transitory computer-readable (processor-readable) storage medium that executes on one or more processors of a device. The processors of the device are specifically configured to execute the product-specific supply chain manager. The product-specific supply chain manager has access to one or more networks; the networks can be wired, wireless, or a combination of wired and wireless.

In an embodiment, the product-specific supply chain manager is data structure generator 113, rules manager 114, workflow manager 115, report manager 116, API 117, and/or method 200. In an embodiment, the device that executes the product-specific supply chain manager is server 110 or cloud 110. In an embodiment, the product-specific supply chain manager interacts with represents another, and in ways, enhanced processing perspective to that which was shown in system 100 and method 200.

At 310, the product-specific supply chain manager segments products of an entity into segments. Each segment includes segmentation elements associated with a supply chain of a corresponding product.

At 320, the product-specific supply chain manager determines a value or characteristic for each segmentation element based on supply chain data maintained by the entity and further based on segmentation criteria defined by the entity for each segmentation element.

At 330, the product-specific supply chain manager generates a control data structure for each segment of each product. Each control data structure identifies the segmentation elements and a corresponding value or characteristic to each segmentation element.

In an embodiment, at 331, the product-specific supply chain manager stores the control data structures as records within a data store. An example record is presented above with the discussion of FIG. 1B.

At 340, the product-specific supply chain manager assigns one or more supply chain decisions to each segment of each product based on a corresponding control data structure and based on supply chain rules associated with the corresponding control data structure.

In an embodiment of 331 and 340, at 341, the product-specific supply chain manager links the supply chain rules to corresponding records as a whole, combinations of fields of a given record, or a single field of the given record. For example, in FIG. 1B a supply chain rule can be linked to all the records for product 123, a second supply chain rule can be linked to the fields associated with the COVID Important and Vendor Reliability segmentation elements, and a third supply chain rule can be linked to just the Volatility segmentation element.

At 350, the product-specific supply chain manager integrates at least one decision into a workflow of a system 123. This causes system 123 to perform an action, to provide the decision, or to provide a recommendation for the decision with respect to at least one supply chain of at least one product managed by the entity.

In an embodiment, at 360, the product-specific supply chain manager provides the control data structures to the system 123 or to a different system 123. The different system 123 can be associated with the entity or associated with a different entity involved in the corresponding supply chain for the corresponding product.

In an embodiment, at 370, the product-specific supply chain manager integrates the control data structures into at least one additional workflow of at least one additional system 123, which is associated with a different entity involved in the corresponding supply chain of the corresponding product.

It should be appreciated that where software is described in a particular form (such as a component or module) this is merely to aid understanding and is not intended to limit how software that implements those functions may be architected or structured. For example, modules may be illustrated as separate modules, but may be implemented as homogenous code, as individual components, a combination, but not all of these modules may be combined, or the functions may be implemented in software structured in any other convenient manner.

Furthermore, although the software modules are illustrated as executing on one piece of hardware, the software may be distributed over multiple processors of a single device, or in any other convenient manner.

The above description is illustrative, and not restrictive. Other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
segmenting available products of an entity into product segments, each product segment associated with a given product;
generating a control data structure for each product segment, each control data structure includes segmentation elements and a value or characteristic for each segmentation element; and
providing the control data structures to a workflow of a system causing the system to perform one or more actions within the workflow based on the control data structures.

2. The method of claim 1, wherein segmenting further includes obtaining supply chain data maintained by the entity.

3. The method of claim 2, wherein obtaining further includes cleaning the obtained supply chain data.

4. The method of claim 3, wherein cleaning further includes calculating statistical values for each segmentation element from cleansed data.

5. The method of claim 4, wherein calculating further includes obtaining segmentation criteria defined by the entity for each segmentation element.

6. The method of claim 5, wherein generating further includes determining the value or the characteristic for each segmentation element of each product segment based on a corresponding calculated statistical value and corresponding segmentation criteria.

7. The method of claim 6, wherein determining further includes rendering the control data structures as strings, each string represents a corresponding product segment for a corresponding product of the entity, and each string identifies each segmentation element and a corresponding value or characteristic.

8. The method of claim 1, wherein generating further includes providing supply chain data maintained by the entity, the segmentation elements, and segmentation criteria defined by the entity as input to a machine learning model (model), receiving cleansed data for the supply chain data and updated segmentation criteria for each segmentation element as output from the model, and generating the control data structure for each product segment using the cleansed data and the updated segmentation criteria.

9. The method of claim 1, wherein providing further includes publishing the control data structures for access by the system associated with the entity.

10. The method of claim 1, wherein providing further sending the control data structures to the system via an application programming interface.

11. The method of claim 1 further comprising:
updating the control data structures for the products and the entity at a preconfigured interval of time based on updated supply chain data relevant to the products and the entity.

12. The method of claim 1 further comprising:
using updated supply chain relevant to the products and the entity and the control data structures to generate reports; and
providing the reports to the entity through an interface.

13. The method of claim 1 further comprising providing compliance data within a report for each product using predefined rules associated with a corresponding control data structure of a corresponding product segment for the corresponding product.

14. A method, comprising:
segmenting products of an entity into segments, each segment including segmentation elements associated with a supply chain of a corresponding product;
determining a value or characteristic for each segmentation element of each segment based on supply chain data maintained by the entity and based on segmentation criteria defined by the entity for each segmentation element;
generating a control data structure for each segment of each product, wherein each control data structure identifies the segmentation elements and a corresponding value or characteristic assigned to each segmentation element;
assigning one or more supply chain decisions to each segment of each product based on a corresponding control data structure and based on supply chain rules associated with the corresponding control data structure; and
integrating at least one supply chain decision into a workflow of a system causing the system to perform at least one action, to provide the at least one decision, or to provide at least one recommendation with respect to at least one supply chain of at least one product managed by the entity.

15. The method of claim 14, wherein generating further includes storing the control data structures as records within a data store.

16. the method of claim 15, wherein assigning further includes linking the supply chain rules to corresponding records as a whole, combinations of fields of a given, or a single field of the given record.

17. The method of claim 14 further comprising, providing the control data structures and the supply chain rules to the system or to a different system that is associated with the entity or is associated with a different entity.

18. The method of claim 14 further comprising:
integrating the control data structures into at least one additional workflow of at least one additional system associated with a different entity.

19. A system, comprising:
at least one server comprising at least one processor and a non-transitory computer-readable storage medium with executable instructions; and
the executable instructions when executed by the processor cause the processor to perform operations comprising:
generating a control data structure for a supply chain of a product associated with at least one entity by defining a supply chain segment to the product, the supply chain segment includes segmentation elements corresponding to the product, assigning a value or a characteristic to each segmentation element based on segmentation criteria for a corresponding segmentation element and based on data that is relevant to the supply chain, and producing the control data structure using the segmentation elements and corresponding assigned values of characteristics; and
integrating the control data structure into at least one workflow associated with at least one system of the at least one entity causing the at least one workflow to perform an action, to provide an decision, or to make a recommendation for a certain decision with respect to the product based on real-time data relevant to the supply chain received by the at least one system and based on supply chain rules associated with the segmentation elements of the control data structure or associated with the control data structure as a whole.

20. The system of claim 19, wherein the executable instructions when executed by the processor further cause the processor to perform additional operations comprising:
providing a report at a segmentation element level of detail for the supply chain of the product through at least one interface to the at least one entity at a configured interval of time based on the real-time data and the supply chain rules.
